(19) United States
(12) Patent Application Publication
(10) Pub. No.: US 2009/0078076 A1
(43) Pub. Date: Mar. 26, 2009

(54) Adjustable handlebar stem assembly

(76) Inventor: CHAO-HU CHEN, Shengang Township (TW)

Correspondence Address: PHILLIP LIU, 6980, WHITEOAK DR., RICHMOND, BC, V7EAZ9, CA

(21) Appl. No.: 11/902,543

(22) Filed: Sep. 24, 2007

(51) Int. Cl. B62K 21/12

(52) U.S. Cl. 74/551.8

(57) ABSTRACT

A handlebar stem assembly includes a tubular stem having a first end connected to a handlebar and a second end of the stem includes a cap member connected thereto so as to form a space therebetween in which a connection member is received. The connection member is connected to the steerer tube. The cap member includes a first toothed surface in an inner surface thereof and the connection member includes a second toothed surface defined in an outer surface thereof, the first and second toothed surfaces are engaged with each other.

### FIELD OF THE INVENTION

The present invention relates to an adjustable handlebar stem assembly wherein the handlebar stem can be adjustable relative to a connection member fixed on the steerer tube.

### BACKGROUND OF THE INVENTION

A conventional handlebar stem assembly generally includes a first end to which the handlebar is connected and a second end which is securely mounted to a steerer tube on the front fork. The second end of the handlebar stem includes two slits which are in communicating with the hollow stem and the two slits are located on different axes. A bolt extends laterally through the second end of the stem so as to fix the steerer tube to the second end of the handlebar stem. Because the two slits are located at two different axes so that the clamping force to the steerer tube is not concentrated and this arrangement prevents the steerer tube from being broken when the clamping force is overly applied. However, the angles of the handlebar cannot be adjusted and the orientation of the handlebar cannot meet needs of different users or different types of riding.

The present invention intends to provide a handlebar stem assembly which includes a connection member received in an end of the stem and the connection member is fixed to the steerer tube. The second end of the handlebar stem is rotatably mounted to the connection member so that the user can easily adjust the angle of the handlebar.

### SUMMARY OF THE INVENTION

The present invention relates to a handlebar stem assembly which comprises a tubular stem and a handlebar is connected to a first end thereof and a cap member is connected to a second end of the stem. A space is defined between the cap member and the second end of the stem so as to receive a connection member therein. The connection member is securely connected with a steerer tube and securely in contact with the cap member.

The primary object of the present invention is to provide a handlebar stem assembly wherein the angle of the stem can be adjusted by rotate the stem relative to the connection member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handlebar stem assembly of the present invention;

FIG. 2 is a perspective view to show the handlebar stem assembly of the present invention;

FIG. 3 is a cross sectional view to show the handlebar stem assembly of the present invention;

FIG. 4 shows that the stem is pivoted downward relative to the steerer tube, and FIG. 5 shows that the stem is pivoted upward relative to the steerer tube.

### DETAILED DESCRIPTION OF THE PREFERRED EMBODIMENT

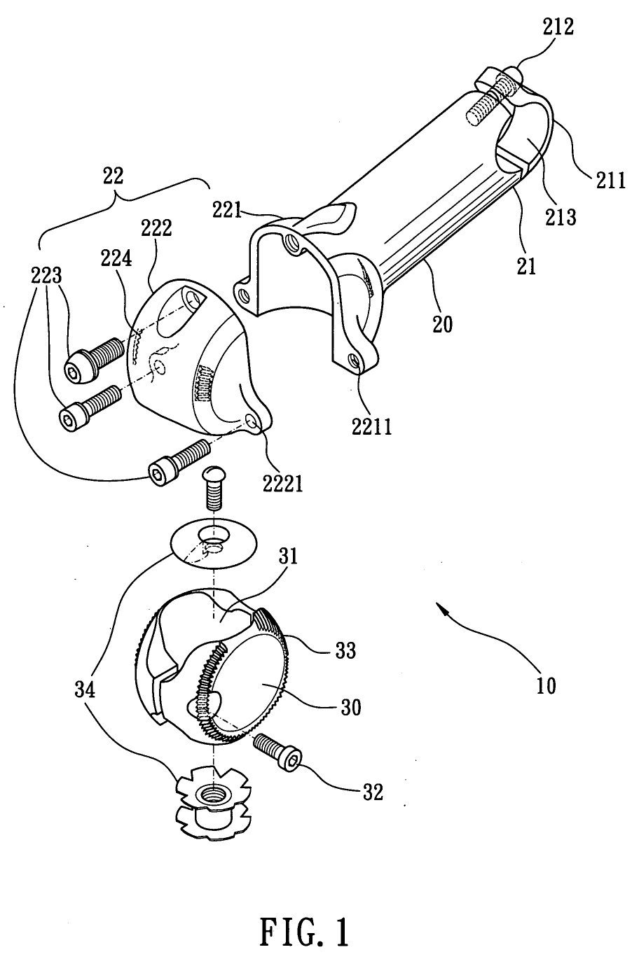

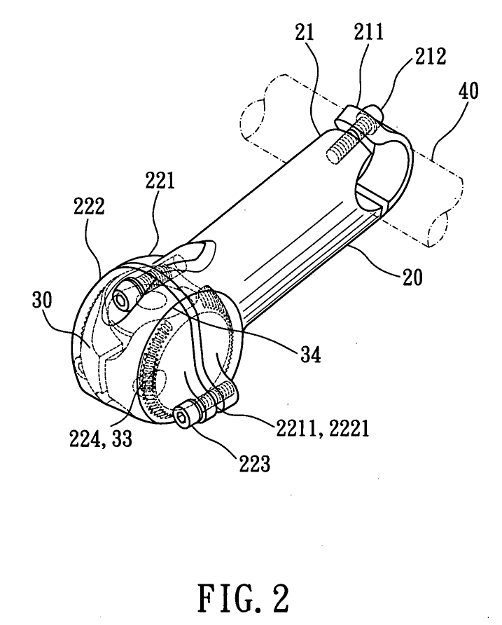

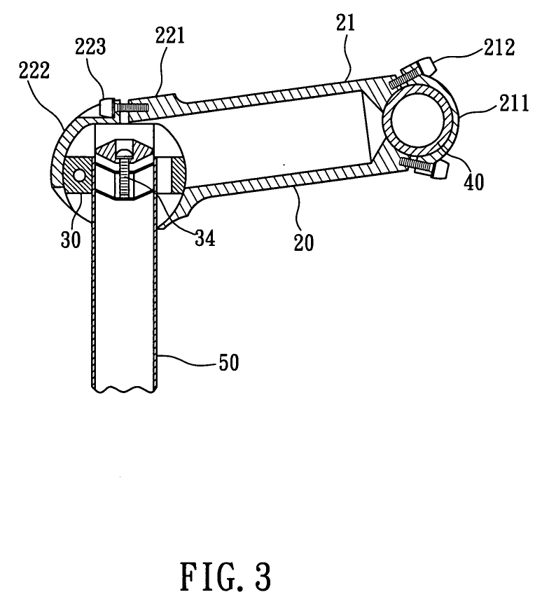

Referring to FIGS. 1 to 3, the handlebar stem assembly 10 of the present invention comprises a tubular stem 20 which includes a first end 21 with a concaved end surface and a curved securing member 211 is mounted to the first end 21 of the stem 20 by two bolts 212. A first passage 213 is defined between the securing member 211 and the first end 21 of the stem 20, a handlebar 40 extends through the first passage 213 and is secured by tightening the two bolts 212. A second end 221 of the stem 20 has a concaved end surface and three threaded holes 2211 are defined in the second end 221 of the stem 20. An adjusting device 22 is connected to the second end of the stem 20 and includes a curved cap member 222 includes three through holes 2221 which are located in aligned with the three threaded holes 2211. Three bolts 223 extend through the through holes 2221 and are connected to the threaded holes 2211. A space is defined between the cap member 222 and the second end 221 of the stem 20.

A connection member 30 is received in the space and securely in contact with the cap member 222. The cap member 222 includes two first toothed surfaces 224 defined in an inner surface thereof and the connection member 30 includes two second toothed surfaces 33 defined in an outer surface thereof, the first toothed surfaces 224 are engaged with the second toothed surfaces 33. The connection member 30 is a tubular member which includes a second passage 31 which is perpendicular to an axis of the tubular member and the steerer tube 50 extends through the second passage 31. A slit is defined perpendicular to the axis of the tubular member and a bolt 32 extends through two sides of the slit to clamp the steerer tube 50 in the second passage 31. An urging device 34 is used to securely connect the steerer tube 50 and the connection member 30. The urging device 34 includes a top cap and an expandable set which is received in the steerer tube, a bolt extends through the top cap and is threadedly connected to the expandable set which is expanded to securely contact inner surface of the steerer tube 50.

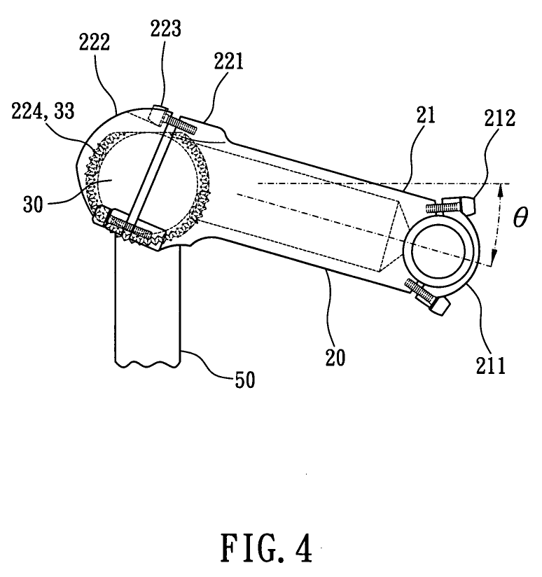

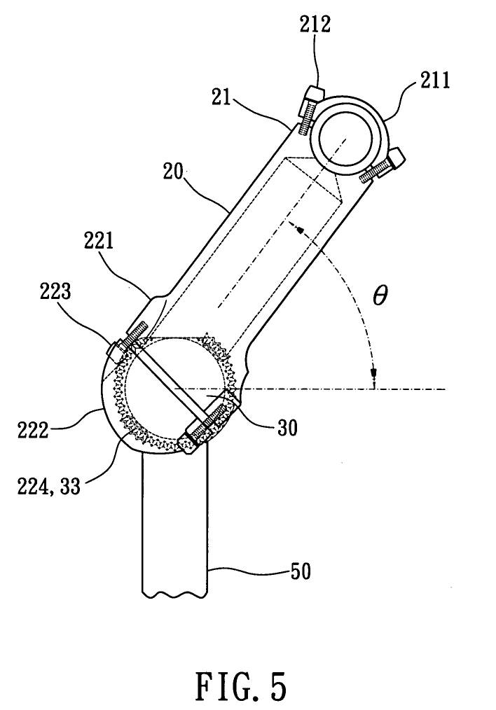

As shown in FIGS. 4 and 5, when adjusting the angle of the stem 20, the three bolts 223 are slightly loosened so that the first toothed surfaces 224 are disengaged from the second toothed surfaces 33. The user then pivots the stem 20 an angle “θ” about the connection member 30 and tightens the bolts 223 again to engage the first and second toothed surfaces 224, 33. The engagement of the first and second toothed surfaces 224, 33 ensures that the stem 20 is maintained at the desired angle.

While we have shown and described the embodiment in accordance with the present invention, it should be clear to those skilled in the art that further embodiments may be made without departing from the scope of the present invention.

What is claimed is:

1. A handlebar stem assembly comprising:
a tubular stem having a first end adapted to be connected to a handlebar and a second end of the stem having a cap member connected thereto, a space defined between the cap member and the second end of the stem, and
a connection member received in the space and being securely in contact with the cap member, the connection member adapted to be connected with a steerer tube.

2. The assembly as claimed in claim 1, wherein a securing member is mounted to the first end of the stem by two bolts, a first passage is defined between the securing member and the first end of the stem, the first passage is adapted to receive the handlebar.

3. The assembly as claimed in claim 1, wherein the cap member includes three through holes and three threaded holes are defined in the second end of the stem, three bolts extend through the through holes and are connected to the threaded holes.

4. The assembly as claimed in claim 1, wherein the cap member includes two first toothed surfaces defined in an inner surface thereof and the connection member includes two second toothed surfaces defined in an outer surface thereof, the first toothed surfaces are engaged with the second toothed surfaces.

5. The assembly as claimed in claim 4, wherein the connection member is a tubular member which includes a second passage which is perpendicular to an axis of the tubular member and adapted to receive the steerer tube, a slit is defined perpendicular to the axis of the tubular member and a bolt extends through two sides of the slit.

6. The assembly as claimed in claim 1, wherein an urging device includes a top cap and an expandable set which is adapted to be received in the steerer tube, a bolt extends through the top cap and threadedly connected to the expandable set which is expanded to be adapted to securely contact inner surface of the steerer tube.
